(19) United States
(12) Patent Application Publication
(10) Pub. No.: US 2021/0172222 A1
(43) Pub. Date: Jun. 10, 2021

(54) SAFETY FENCE

(71) Applicant: Shenzhen Liyijiujiu Network Technology Co., Ltd., Shenzhen (CN)

(72) Inventor: Xuzhong WANG, Dongguan (CN)

(73) Assignee: Shenzhen Liyijiujiu Network Technology Co., Ltd., Shenzhen (CN)

(21) Appl. No.: 16/742,921

(22) Filed: Jan. 15, 2020

(30) Foreign Application Priority Data
Dec. 10, 2019 (CN) 201922199965.9

(51) Int. Cl. E05C 9/02; E05C 3/06; E06B 9/02; E05C 1/14; E06B 9/00

(52) U.S. Cl. CPC E05C 9/02; E05C 3/06; E06B 2009/002; E05C 1/14; E06B 9/02

(57) ABSTRACT

The utility model discloses a safety fence, comprising a door lock kit, a sliding switch key, a lock cylinder spring, a lock cylinder, a lock cylinder sleeve, a lock cylinder cover, a lock head, a bolt positioner, a nut, a bolt, a handle switch spring, a door lock fixing part, a handle switch key, a linkage rod kit, a linkage rod, a main body movable door, a rotating shaft kit, a rotating shaft wear-resistant part, a rotating shaft fixing part, a rotating shaft spring, a fixed door frame, a bottom movable switch fixing part, a bottom movable switch spring, a bottom movable switch, a bottom movable switch sleeve, a one-way and two-way setting movable part, a one-way and two-way setting fixing part and the like.

### TECHNICAL FIELD

The utility model relates to a safety fence, and belongs to the technical field of infant supplies or pet supplies.

### BACKGROUND

At present, the existing safety fences of the same category are installed in two methods: installing by a bolt pressure on both sides and fixing by drilling lock screws. Both fences can be used to prevent infants or pets from passing.

The above pressure-installed safety fence provides pressure through the bolts and nuts on both sides to press the opening of the door frame to the middle, adjusts the position of the nut to the correct position of the door lock, and then can be used normally. The above safety fence provides an installation method that does not need to damage the wall or the door frame. Extensions can be added on both sides to adapt to a larger space, and the rotating shaft part has a structure to keep the door open and automatically reset. At present, the space for opening the door in the middle of such safety fences on the market is smaller, and the plastic rotating shaft part is not wear-resistant. It is easy for the structure that keeps the door open and automatically resets to wear; when being unlocked, it is unlocked by pressing or lifting, but it will be blocked by a steel pipe when being unlocked, and there is a lack of experience.

The safety fence of the above drilling lock screw fixes the framework of the safety fence by drilling holes on both sides, providing a more stable installation method. Extensions can be added to adapt to a larger space, and the rotating shaft part has a structure to keep the door open and automatically reset. This type of safety fences needs to damage the wall or door frame, and requires professional drilling tools, which is cumbersome to install; the space for opening the door in the middle is smaller, the plastic rotating shaft part is not wear-resistant, and it is easy for the structure that keeps the door open and automatically resets to wear.

### SUMMARY

The purpose of the utility model is to overcome the shortcomings of the prior art and provides a safety fence with a new structure.

The technical solutions adopted by the utility model to solve the above technical problems are as follows:

A safety fence, comprising: a door lock kit (1), a sliding switch key (2), a lock cylinder spring (3), a lock cylinder (4), a lock cylinder sleeve (5), a lock cylinder cover (6), a lock head (7), a bolt positioner (8), a nut (9), a bolt (10), a handle switch spring (11), a door lock fixing part (12), a handle switch key (13), a linkage rod kit (14), a linkage rod (15), a main body movable door (16), a rotating shaft kit (17), a rotating shaft wear-resistant part (18), a rotating shaft fixing part (19), a rotating shaft spring (20), a fixed door frame (21), a bottom movable switch fixing part (22), a bottom movable switch spring (23), a bottom movable switch (24), a bottom movable switch sleeve (25), a one-way and two-way setting movable part (26), a one-way and two-way setting fixing part (27), a bottom movable switch fixing groove (28), a bottom rotating shaft (29), a rotating shaft fixing screw (30), and a bottom door frame (31); wherein the main body movable door (16) is assembled to the door lock kit (1) and the rotating shaft kit (17), and the bolt positioner (8), the nut (9), and the bolt (10) are assembled to both sides of the door lock kit (1), the rotating shaft kit (17), and the bottom door frame (31); the safety fence is placed on the bolt positioner (8) through four bolts (10), adjusts the nut (9) to be matched with the required size, and fixes the fixed door frame (21) to the required position.

Preferably, the door lock kit (1) is equipped with a sliding switch key (2), a lock cylinder spring (3), a lock cylinder (4), a lock cylinder sleeve (5), a lock cylinder cover (6), a handle switch spring (11), a door lock fixing part (12), and a handle switch key (13), wherein the sliding switch key (2), the lock cylinder spring (3), the lock cylinder (4) and the lock cylinder sleeve (5) form a movable component, the sliding switch key (2) slides backward to drive the lock cylinder (4), the lock cylinder sleeve (5) moves backward, and when the lock cylinder (4) moves to be flush with the lock cylinder cover (6), the upper door lock is in an unlocked state.

Preferably, the handle switch spring (11), the handle switch key (13), the linkage rod (15), the bottom movable switch fixing part (22), the bottom movable switch spring (23), the bottom movable switch (24), the bottom movable switch cover (25), and the bottom movable switch fixing groove (28) form a lower door lock structural component together, wherein the handle switch key (13) lifts upward to drive the bottom movable switch spring (23) and the bottom movable switch (24) to move, when the bottom movable switch (24) moves up beyond the slot of the bottom movable switch fixing slot (28), the lower door lock is in an unlocked state, and when the upper door lock is unlocked, the lower door lock is unlocked at the same time so as to achieve the door opening effect.

Preferably, the rotating shaft kit (17), the rotating shaft wear-resistant part (18), the rotating shaft fixing part (19), the rotating shaft spring (20), the bottom rotating shaft (29) and the rotating shaft fixing screw (30) form a rotating shaft structural component together.

Preferably, the safety fence drives the lock cylinder spring (3), the lock cylinder (4), and the lock cylinder sleeve (5) to move backward to unlock the upper switch by sliding the switch key (2), and the handle switch key (13) drives the linkage rod (15) upward at the same time to unlock the bottom switch (24) so as to achieve the door opening effect;

when the main body movable door (16) is turned to 90 degrees, the rotating shaft kit (17) moves to the locking position of the rotating shaft wear-resistant part (18) to keep the door open, when it is less than 90 degrees, the main body movable door (16) is automatically reset, the lock cylinder (4) slides over the lock head ramp (7a), and the bottom movable switch (24) slides over the bottom movable switch fixing groove (28) to complete automatic locking up and down.

Preferably, the safety fence sets the opening direction of the main body movable door (16) by adjusting the position of the one-way and two-way setting movable part (26).

Preferably, the safety fence lock cylinder (4), the nut (9), the rotating shaft wear-resistant part (18), and the bottom movable switch (24) are all made of wear-resistant material.

Preferably, the safety fence nut (9) is added with a locking structure and cooperates with the bolt positioner (8), which is less likely to loosen after installation and is more stable.

Other features and advantages of the utility model will be explained in the following description, and will partly become apparent from the description, or be understood by implementing the utility model. The objects and other advantages of the utility model can be achieved and obtained through the structures specifically pointed out in the written description, claims, and drawings.

### BRIEF DESCRIPTION OF THE DRAWINGS

The utility model is described in detail below with reference to the drawings, so as to make the above advantages of the utility model clearer.

FIG. 1 is an exploded diagram illustrating a safety fence according to the utility model;

FIG. 2 is a product diagram illustrating a safety fence according to the utility model;

FIG. 3 is a sectional diagram illustrating a door lock of a safety fence according to the utility model;

FIG. 4 is a sectional diagram illustrating a rotating shaft of a safety fence according to the utility model;

FIG. 5 is a sectional diagram illustrating a bottom movable switch component of a safety fence according to the utility model;

FIG. 6 is a positioning diagram illustrating a nut and a bolt of a safety fence according to the utility model.

FIG. 7 is a diagram illustrating a bottom bidirectional switch component of a safety fence according to the utility model.

### DESCRIPTION OF THE EMBODIMENTS

The utility model will be described in detail below with reference to specific embodiments.

The first technical problem solved by the utility model is to increase the space for opening the door so that users can pass through more conveniently.

The second technical problem solved by the utility model is that a separate wear-resistant part is added to the rotating shaft part, and a plastic material with better wear resistance is used to improve the service life of the product.

The third technical problem solved by the utility model is that the design of the door lock is simpler, the linkage of the bottom switch moves forward, no obstacle is blocked by the switch position, and the unlocking experience is better.

The fourth technical problem solved by the utility model is that the one-way and two-way setting switch at the bottom is limited to a 90-degree range of movement, and the positioning structure is increased, which makes it difficult for infants to move and improve safety.

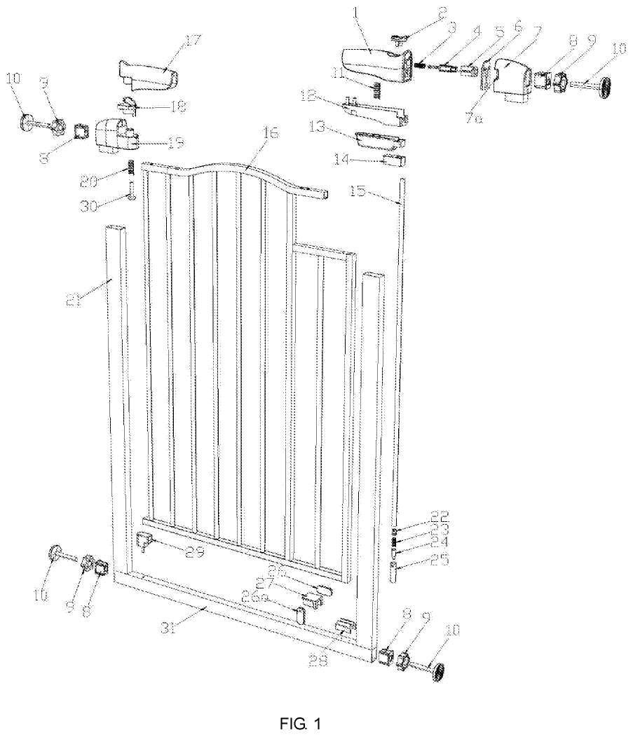

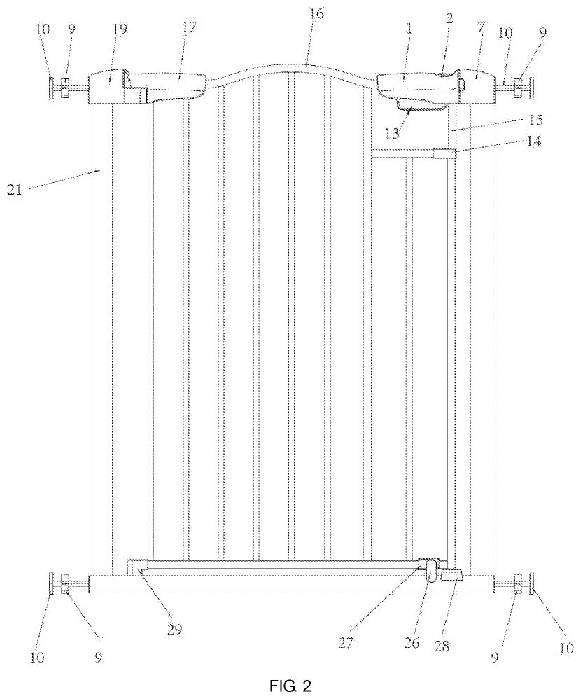

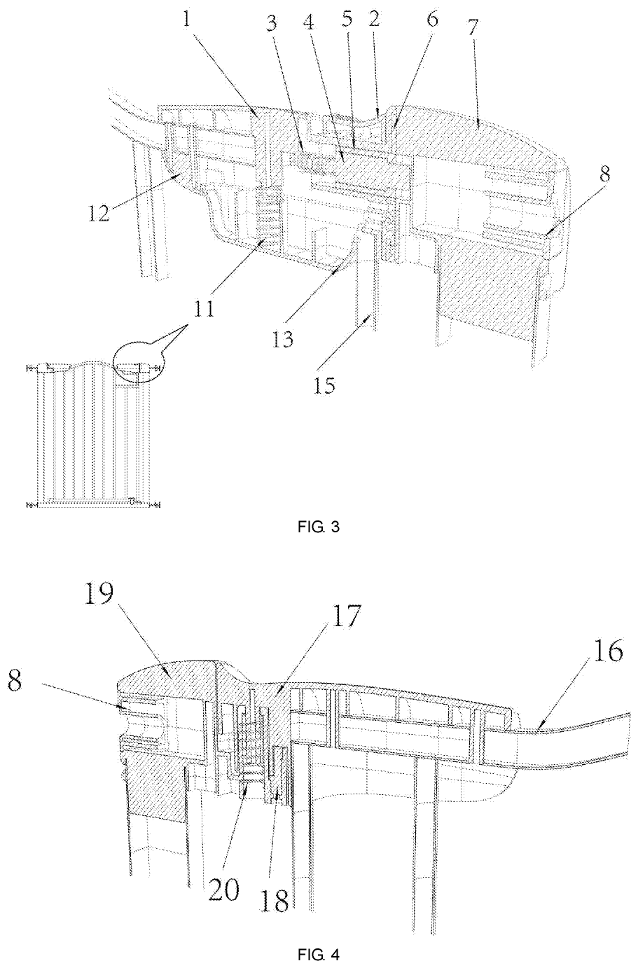

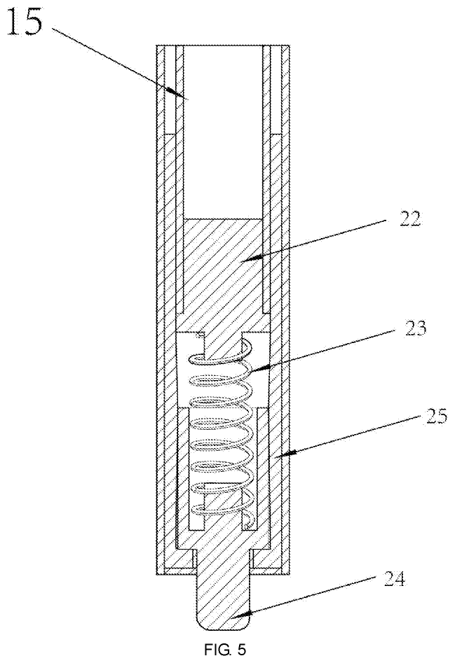

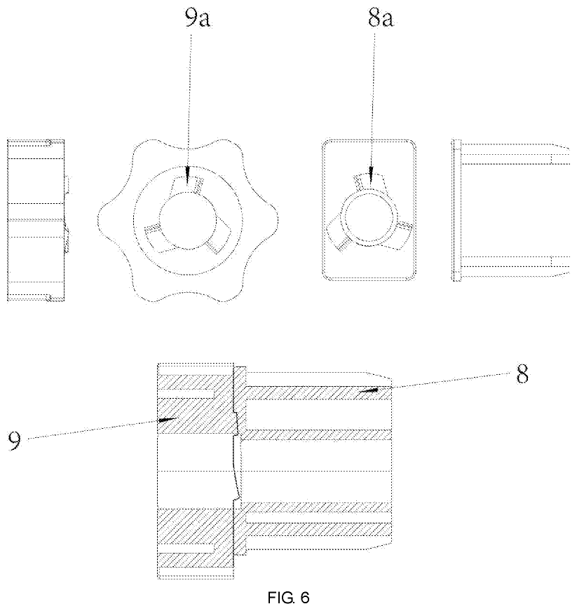

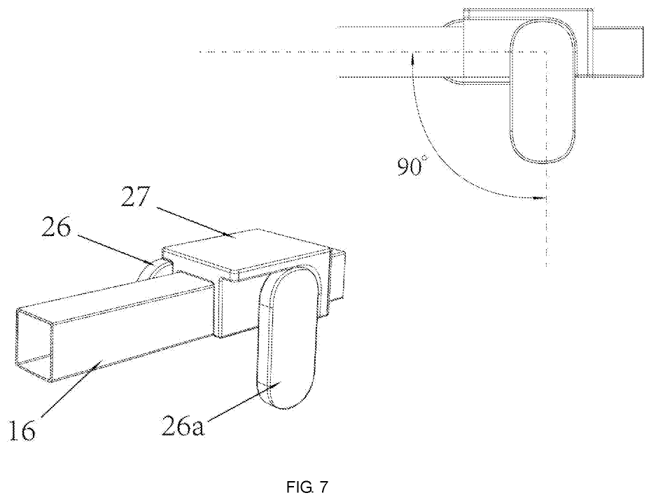

As shown in FIGS. 1-7, the safety fence according to the utility model comprises: a safety fence, comprising: a door lock kit (1), a sliding switch key (2), a lock cylinder spring (3), a lock cylinder (4), a lock cylinder sleeve (5), a lock cylinder cover (6), a lock head (7), a lock head ramp (7a), a bolt positioner (8), a bolt positioner locker (8a), a nut (9), a nut locker (9a), a bolt (10), a handle switch spring (11), a door lock fixing part (12), a handle switch key (13), a linkage rod kit (14), a linkage rod (15), a main body movable door (16), a rotating shaft kit (17), a rotating shaft wear-resistant part (18), a rotating shaft fixing part (19), a rotating shaft spring (20), a fixed door frame (21), a bottom movable switch fixing part (22), a bottom movable switch spring (23), a bottom movable switch (24), a bottom movable switch sleeve (25), a one-way and two-way setting movable part (26) (26a), a one-way and two-way setting fixing part (27), a bottom movable switch fixing groove (28), a bottom rotating shaft (29), a rotating shaft fixing screw (30), and a bottom door frame (31);

wherein the main body movable door (16) is assembled to the door lock kit (1) and the rotating shaft kit (17), and the bolt positioner (8), the nut (9), and the bolt (10) are assembled to both sides of the door lock kit (1), the rotating shaft kit (17), and the bottom door frame (31); the safety fence is placed on the bolt positioner (8) through four bolts (10), adjusts the nut (9) to be matched with the required size, and fixes the fixed door frame (21) to the required position.

Preferably, the door lock kit (1) is equipped with a sliding switch key (2), a lock cylinder spring (3), a lock cylinder (4), a lock cylinder sleeve (5), a lock cylinder cover (6), a handle switch spring (11), a door lock fixing part (12), and a handle switch key (13), wherein the sliding switch key (2), the lock cylinder spring (3), the lock cylinder (4) and the lock cylinder sleeve (5) form a movable component, the sliding switch key (2) slides backward to drive the lock cylinder (4), the lock cylinder sleeve (5) moves backward, and when the lock cylinder (4) moves to be flush with the lock cylinder cover (6), the upper door lock is in an unlocked state.

Preferably, the handle switch spring (11), the handle switch key (13), the linkage rod (15), the bottom movable switch fixing part (22), the bottom movable switch spring (23), the bottom movable switch (24), the bottom movable switch cover (25), and the bottom movable switch fixing groove (28) form a lower door lock structural component together, wherein the handle switch key (13) lifts upward to drive the bottom movable switch spring (23) and the bottom movable switch (24) to move, when the bottom movable switch (24) moves up beyond the slot of the bottom movable switch fixing slot (28), the lower door lock is in an unlocked state, and when the upper door lock is unlocked, the lower door lock is unlocked at the same time so as to achieve the door opening effect.

Preferably, the rotating shaft kit (17), the rotating shaft wear-resistant part (18), the rotating shaft fixing part (19), the rotating shaft spring (20), the bottom rotating shaft (29) and the rotating shaft fixing screw (30) form a rotating shaft structural component together.

Preferably, the safety fence drives the lock cylinder spring (3), the lock cylinder (4), and the lock cylinder sleeve (5) to move backward to unlock the upper switch by sliding the switch key (2), and the handle switch key (13) drives the linkage rod (15) upward at the same time to unlock the bottom switch (24) so as to achieve the door opening effect;

when the main body movable door (16) is turned to 90 degrees, the rotating shaft kit (17) moves to the locking position of the rotating shaft wear-resistant part (18) to keep the door open, when it is less than 90 degrees, the main body movable door (16) is automatically reset, the lock cylinder (4) slides over the lock head ramp (7a), and the bottom movable switch (24) slides over the bottom movable switch fixing groove (28) to complete automatic locking up and down.

The safety fence is placed on the bolt positioner (8) through four bolts (10), adjusts the nut (9) to be matched with the required size, and fixes the fixed door frame (21) to the required position.

The safety fence drives the lock cylinder spring (3), the lock cylinder (4), and the lock cylinder sleeve (5) to move backward to unlock the upper switch by sliding the switch key (2), and the handle switch key (13) drives the linkage rod (15) upward at the same time to unlock the bottom switch (24) so as to achieve the door opening effect. When the main body movable door (16) is turned to 90 degrees, the rotating shaft kit (17) moves to the locking position of the rotating shaft wear-resistant part (18) to keep the door open, when it is less than 90 degrees, the main body movable door (16) is automatically reset, the lock cylinder (4) slides over the lock head ramp (7a), and the bottom movable switch (24) slides over the bottom movable switch fixing groove (28) to complete automatic locking up and down.

The safety fence sets the opening direction of the main body movable door (16) by adjusting the position of the one-way and two-way setting movable part (26).

The safety fence lock cylinder (4), the nut (9), the rotating shaft wear-resistant part (18), and the bottom movable switch (24) are all made of wear-resistant material.

The safety fence nut (9) is added with a locking structure and cooperates with the bolt positioner (8), which is less likely to loosen after installation and is more stable.

The safety fence of the utility model has a larger door opening space, and the two switches of the door lock can be more easily operated. The lock cylinder (4), the nut (9), the rotating shaft wear-resistant part (18), and the bottom movable switch (24) are all made of wear-resistant material to improve the service life of the product. The pressure-installed nuts increase the locking structure, which is less likely to loosen and provide a more stable structure. The one-way and two-way setting switch at the bottom increases positioning and moving range. It is not easy for infants to move the safety fence.

The safety fence of the utility model is applied to infant or pet protection products. The door opening space is large, the lock operation is simple, and the wear resistance is high, which can bring better product experience to users.

Finally, it should be noted that the above description is only the preferred embodiment of the utility model and is not used to limit the utility model. Although the utility model has been described in detail with reference to the foregoing embodiments it will be apparent to those skilled in the art that the technical solutions described in the foregoing embodiments can be still modified, or some of the technical features are equivalently replaced. Any modification, equivalent replacement, or improvement made within the spirit and principle of the utility model shall be included in the scope of protection of the utility model.

What is claimed is:

1. A safety fence, comprising: a door lock kit (1), a sliding switch key (2), a lock cylinder spring (3), a lock cylinder (4), a lock cylinder sleeve (5), a lock cylinder cover (6), a lock head (7), a bolt positioner (8), a nut (9), a bolt (10), a handle switch spring (11), a door lock fixing part (12), a handle switch key (13), a linkage rod kit (14), a linkage rod (15), a main body movable door (16), a rotating shaft kit (17), a rotating shaft wear-resistant part (18), a rotating shaft fixing part (19), a rotating shaft spring (20), a fixed door frame (21), a bottom movable switch fixing part (22), a bottom movable switch spring (23), a bottom movable switch (24), a bottom movable switch sleeve (25), a one-way and two-way setting movable part (26), a one-way and two-way setting fixing part (27), a bottom movable switch fixing groove (28), a bottom rotating shaft (29), a rotating shaft fixing screw (30), and a bottom door frame (31); wherein the main body movable door (16) is assembled to the door lock kit (1) and the rotating shaft kit (17), and the bolt positioner (8), the nut (9), and the bolt (10) are assembled to both sides of the door lock kit (1), the rotating shaft kit (17), and the bottom door frame (31); the safety fence is placed on the bolt positioner (8) through four bolts (10), adjusts the nut (9) to be matched with the required size, and fixes the fixed door frame (21) to the required position.

2. The safety fence according to claim 1, wherein the door lock kit (1) is equipped with a sliding switch key (2), a lock cylinder spring (3), a lock cylinder (4), a lock cylinder sleeve (5), a lock cylinder cover (6), a handle switch spring (11), a door lock fixing part (12), and a handle switch key (13), wherein the sliding switch key (2), the lock cylinder spring (3), the lock cylinder (4) and the lock cylinder sleeve (5) form a movable component, the sliding switch key (2) slides backward to drive the lock cylinder (4), the lock cylinder sleeve (5) moves backward, and when the lock cylinder (4) moves to be flush with the lock cylinder cover (6), the upper door lock is in an unlocked state.

3. The safety fence according to claim 1, wherein the handle switch spring (11), the handle switch key (13), the linkage rod (15), the bottom movable switch fixing part (22), the bottom movable switch spring (23), the bottom movable switch (24), the bottom movable switch cover (25), and the bottom movable switch fixing groove (28) form a lower door lock structural component together, wherein the handle switch key (13) lifts upward to drive the bottom movable switch spring (23) and the bottom movable switch (24) to move, when the bottom movable switch (24) moves up beyond the slot of the bottom movable switch fixing slot (28), the lower door lock is in an unlocked state, and when the upper door lock is unlocked, the lower door lock is unlocked at the same time so as to achieve the door opening effect.

4. The safety fence according to claim 1, wherein the rotating shaft kit (17), the rotating shaft wear-resistant part (18), the rotating shaft fixing part (19), the rotating shaft spring (20), the bottom rotating shaft (29) and the rotating shaft fixing screw (30) form a rotating shaft structural component together.

5. The safety fence according to claim 1, wherein the safety fence drives the lock cylinder spring (3), the lock cylinder (4), and the lock cylinder sleeve (5) to move backward to unlock the upper switch by sliding the switch key (2), and the handle switch key (13) drives the linkage rod (15) upward at the same time to unlock the bottom switch (24) so as to achieve the door opening effect;
when the main body movable door (16) is turned to 90 degrees, the rotating shaft kit (17) moves to the locking position of the rotating shaft wear-resistant part (18) to keep the door open, when it is less than 90 degrees, the main body movable door (16) is automatically reset, the lock cylinder (4) slides over the lock head ramp (7a), and the bottom movable switch (24) slides over the bottom movable switch fixing groove (28) to complete automatic locking up and down.

6. The safety fence according to claim 1, wherein the safety fence sets the opening direction of the main body movable door (16) by adjusting the position of the one-way and two-way setting movable part (26).

7. The safety fence according to claim 1, wherein the safety fence lock cylinder (4), the nut (9), the rotating shaft wear-resistant part (18), and the bottom movable switch (24) are all made of wear-resistant material.

8. The safety fence according to claim 1, wherein the safety fence nut (9) is added with a locking structure and cooperates with the bolt positioner (8), which is less likely to loosen after installation and is more stable.

9. The safety fence according to claim 2, wherein the safety fence sets the opening direction of the main body movable door (16) by adjusting the position of the one-way and two-way setting movable part (26).

10. The safety fence according to claim 2, wherein the safety fence lock cylinder (4), the nut (9), the rotating shaft wear-resistant part (18), and the bottom movable switch (24) are all made of wear-resistant material.

11. The safety fence according to claim 2, wherein the safety fence nut (9) is added with a locking structure and cooperates with the bolt positioner (8), which is less likely to loosen after installation and is more stable.
